(19) United States
(12) Patent Application Publication
(10) Pub. No.: US 2005/0228632 A1
(43) Pub. Date: Oct. 13, 2005

(54) Wet chop fiberglass design systems and methods

(76) Inventors: Jennifer Elizabeth Dobmeier, Centennial, CO (US); James Patrick Hamilton, Parker, CO (US); Alan Michael Jaffee, Bowling Green, OH (US)

Correspondence Address: JOHNS MANVILLE;Legal Department, 10100 West Ute Avenue, Littleton, CO, 80127, US

(21) Appl. No.: 10/822,368

(22) Filed: Apr. 12, 2004

(51) Int. Cl. G06F 9/45

(52) U.S. Cl. 703/22

(57) ABSTRACT

A system and method for designing a fibrous non-woven mat production, where the method includes selecting various physical characteristics for at least some of the components to be included in the mat, obtaining empirical performance data relating to the mat based on the selected physical properties, developing a prediction equation for a performance characteristic of the mat based on the empirical data and the physical characteristics, calculating performance characteristics using the prediction equation, where ranges of at least some of the physical characteristics are used in the prediction equation, and selecting components for the mat based on the calculated performance characteristics.

### BACKGROUND OF THE INVENTION

This invention relates generally to the field of making articles such as fibrous non-woven mats. More specifically, the invention includes systems and methods for predicting the performance characteristics of the articles (e.g., tensile and/or tear strength) based on one or more physical characteristics of materials used to make the articles (e.g., glass fiber length and/or diameter).

Fiberglass is found in a variety products, including non-woven mats used in insulation and roofing materials (e.g., shingles). Performance characteristics of the mats depend, to varying degrees, on physical characteristics of the glass fibers as well as the concentrations of various mat components (e.g., the percentage weight of binder materials used in the fiberglass).

Designing a production process for making fiberglass mats often involves trial and error. A variety of variables (sometimes called production components) have to be taken into account during the production process. These variables include both the length and diameter of the glass fibers used to make the mats, and the amount of binder used to bind the fibers together into a non-woven mat. Each of these variables has a range of values that require many prototype mats to be made and tested in order to find a mat with the desired combination of performance characteristics (e.g., tear and tensile strength).

Unfortunately, the production and testing of numerous prototype articles is time consuming, costly, and generally inefficient. However, reducing or eliminating this testing greatly increases the chances of designing a mat production process that will make mats with inferior performance characteristics and overall quality. Thus, there is a need for systems and methods to develop production designs for making mats with desired performance characteristics that do not involve excessive prototype testing.

### BRIEF SUMMARY OF THE INVENTION

One embodiment of the invention includes a method for designing a fibrous non-woven mat production. The method includes selecting various physical characteristics for at least some of the components to be included in the mat and obtaining empirical performance data relating to the mat based on the selected physical properties. The method also includes developing a prediction equation for a performance characteristic of the mat based on the empirical data and the physical characteristics, calculating performance characteristics using the prediction equation, and selecting components for the mat based on the calculated performance characteristics. Ranges of at least some of the physical characteristics are used in the prediction equation.

Another embodiment of the invention includes a system for designing a fibrous non-woven mat production. The system includes a processor to develop a prediction equation to calculate one or more production component values based on a performance characteristic value. The prediction equation is developed from data on a performance characteristic of the mat generated by one or more designed experiments. The system also includes a mat production design comprising one or more production values calculated from a desired performance characteristic value input into the prediction equation.

Another embodiment of the invention includes a method for designing a fibrous non-woven mat production. The method includes selecting physical characteristics for at least some components to be included in the mat. The components include glass fibers and binder, and the physical characteristics include length and diameters of the glass fiber, content (by percentage weight) of the binder, and sizing formulations used. The method also includes obtaining empirical performance data relating to the mat based on the selected physical properties. The empirical performance data may selected from a group consisting of tear strength, tensile strength and dispersion. The method further includes developing a prediction equation for a performance characteristic of the mat based on the empirical data and the physical characteristics, calculating performance characteristics using the prediction equation, and selecting components for the mat based on the calculated performance characteristics. The ranges of at least some of the physical characteristics are used in the prediction equation.

Additional novel features shall be set forth in part in the description that follows, and in part will become apparent to those skilled in the art upon examination of the following specification or may be learned by the practice of the invention. The features and advantages of the invention may be realized and attained by means of the instrumentalities, combinations, and methods particularly pointed out in the appended claims.

### BRIEF DESCRIPTION OF THE DRAWINGS

FIG. 1 shows a flowchart outlining a method for designing the production of a manufactured article according to an embodiment of the invention; and

FIG. 2 shows a system for designing the production of a manufactured according to an embodiment of the invention.

### DETAILED DESCRIPTION OF THE INVENTION

The present invention includes systems and methods for the disciplined production design of manufactured articles with desired performance characteristics. These systems and methods may include running one or more designed experiments (DOEs) to measure the effect of production components, such as materials characteristics (e.g., the physical characteristics of a material) and production characteristics (e.g., the relative amounts of different materials used in the article), on performance characteristics of a manufactured article. The data collected from the designed experiments may be statistically analyzed using computer software to develop a prediction equation that calculates the performance characteristics of the manufactured article based on values input for one or more of the production components. The prediction equation may be used to select production components that will produce the article having the desired performance characteristics.

An accurate prediction equation contributes to faster, more efficient production design for the article by reducing the amount of experimental trial and error required to make the article with the desired performance characteristics. Moreover, the prediction equation may be used to predict values for production components that provide a desired balance between two or more performance characteristics. For example, the prediction equation may be used to predict a value for a production component that comes closest to the desired value of a first performance characteristic, while also minimizing the adverse impact on a second performance characteristic. In more complex examples of the present invention, values for multiple production components (e.g., two or more) may be predicted that provide a desired balance between multiple performance characteristics of the manufactured article.

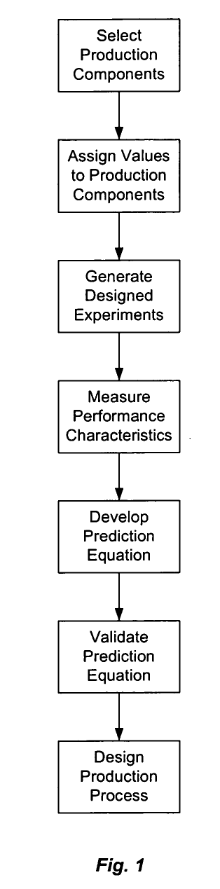

Referring now to FIG. 1, a flowchart outlining a method for designing the production of a manufactured article according to an embodiment of the invention is shown. The method starts by selecting the production components that act as input factors in the data generated by the designed experiments. Production components may have an effect on one or more measured performance characteristic of a manufactured article. In one sense, the production components may be thought of as the independent variables in the data, while the performance characteristics are the dependent variables.

Production components may relate to aspects of the production process that can be categorized and/or measured. They may include materials characteristics, such as the physical characteristics and chemical compositions of the materials used in making the manufactured article. They may also include production characteristics, such as the relative amounts of different materials used, processing times, and processing temperatures, among other production characteristics. Typically, 2 or more production components are selected with the method (e.g., from 4 to 6 components).

In the next step, values are assigned to each of the selected production components. Each production component may have a first and second value that represent the ends of a range of values for the factor. The range may selected as a broad range centered around the average value for the factor that is used, or feasible, in the commercial production of the article. The range may also be selected to ensure large changes are seen in the performance characteristics of the manufactured article. In some instances, such as when a non-linear relationship exists (or is suspected) between a production component and a performance characteristic, three or more values may be chosen for the factor to predict its effect on the article with more accuracy.

After values are assigned to the production components, designed experiments may be generated. In these experiments, the articles are made based on a specific combination of values for the selected production components. A designed experiment may be generated for each unique combination of values for the production components. For example, if there are 3 production components, with each one being assigned 2 values, a total of 8 (i.e., 2×2×2) unique designed experiments can be generated.

The process of creating and performing a designed experiment may include: Stating the problem, stating an objective of the designed experiment, selecting quality characteristics and candidate measurement systems, gauging an R&R study on the candidate measurement system, selecting factors, identifying levels, identifying interactions, designing a trial experiment, conducing the trial experiment, and analyzing and interpreting the trial results.

In the next step, performance characteristics are measured for the articles produced by the designed experiments. Performance characteristics may relate to aspects of the manufactured article that can be categorized and/or measured. For example, performance characteristics may include aspects of the article that can be quantified on a linear scale such as size, weight, density, thickness, basis weight (e.g., lb/100 ft²), loss on ignition (LOI) (e.g., wt. %), tensile strength (e.g., lb/in), tear strength (e.g., grams), retention (e.g., % of tensile strength retained after hot wet bath). Performance characteristics may also include quantities of materials used in the sizing formulation applied to the glass fibers, and the types and quantities of binders used to bind the glass fibers together, among others.

Performance characteristics may also include semi-quantitative aspect of the article such as dispersion (i.e., fiber dispersion), which is the degree of separation of glass fiber bundles into individual filaments during manufacturing processes. Low dispersion may result in glass mats having substantial numbers of fiber bundles, which may cause processing and performance problems in mat applications. Performance characteristics may also include other more subjective qualities of the article such as appearance, feel, color, and taste, among others. Subjective performance characteristics may be made semi-quantifiable by being measured on a rating scale (e.g., a scale from 1 to 5, where 1 represents the most desirable and 5 represents the least desirable).

Once the performance characteristics of the articles are measured, the data generated is used to develop a prediction equation. This step may include inputting the data into a processing device, such as a computer, and analyzing it with one or more software applications that can generate the prediction equation. For example, the data may be analyzed by a statistical software application that fits the data to a linear (e.g., y=mx+b) or non-linear (e.g., y=me^{(1-x)}+b) function representing a prediction equation. In such an equation, one or more of the production components may be represented by independent variables of the function, while a performance characteristic may be represented by a dependent variable.

In the next optional step, the prediction equation that has been developed may be validated by running additional designed experiments. For example, a designed experiment may be run with values for production components not previously used, and the performance characteristics of the article produced may be compared with the predicted values from the prediction equations.

After the prediction equation has been developed and validated, the production process for the article may be designed. The design may include using one or more prediction equations to select values for production components that will produce a manufactured article with desired performance characteristics.

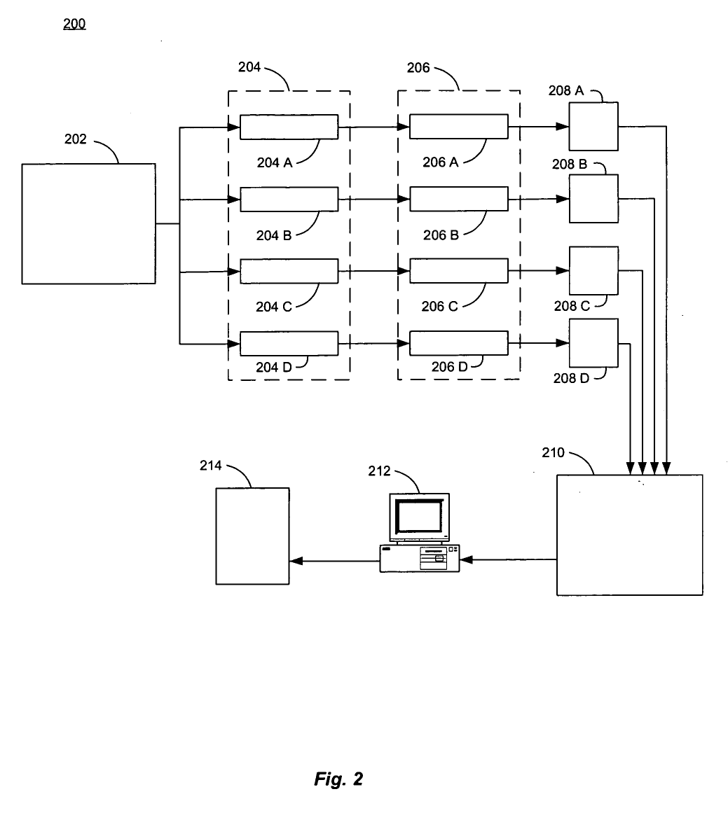

Embodiments of the methods of the invention, like the one illustrated in FIG. 1, may be implemented with systems of the invention, like the embodiment of system 200 shown in FIG. 2. System 200 includes a selection component 202, where production components are selected and values are assigned to the selected components. In this illustrated embodiment, 2 production components are selected, and each component is assigned 2 values.

The values for the first production component 204 are divided into components 204 A-D, where 204 A and 204 B have one value, and 204 C and 204 D have a second value. The values for the second production component 206 are also divided into components 206 A-D, where 206 A and C have a third value, and 206 B and D have a fourth value.

The values of the first and second production components 204, 206 are arranged into 4 unique combinations of designed experiments that produce four manufactured articles 208 A-D. Performance characteristics for each of the articles 208 A-D are then measured with article tester 210. Article tester 210 may include a collection of testing equipment, where each piece of equipment is designed to measure one or more performance characteristic of the article.

Data generated by article tester 210 is transferred to processor 212 (e.g., a computer) which analyzes the data to develop a prediction equation. Processor 212 may use the prediction equation find values for production components that will produce an article with desired performance characteristics. In the embodiment shown, processor 212 outputs a process design plan 214 that includes production component values to produce the desired article. In another embodiment (not shown) processor 212 may be in communication with the equipment that produces the manufactured article and may automatically set the values of the production components.

An example is now described of designing the production of fiberglass mats according to an embodiment of the invention. In this example, designed experiments are conducted that have three factors: 1) The length (in inches) of the glass fibers used in the mat, 2) the diameter (in micrometers) of the glass fibers, and 3) the quantity of binder content (in percent weight) in the mat. Binder content is measured through loss on ignition (LOI) where the glass mat is weighed before and after a high temperature treatment that burns off at least a portion of the binder.

In this example, each factor has two values. The length of the glass fibers have either a first value of 1.25 inches or a second value of 1.70 inches. This diameter of the glass fibers have either a first value of 16 micrometers or a second value of 20 micrometers. The binder content (as measured by LOI) has either a first value of 14% by wt. or a second value of 18% by wt. Table 1 shows the 8 unique combinations of factors produced by the 3 factors:

TABLE 1
Factor Value Combinations for Production of Glass Mat

| Binder Content (% wt.) | Fiber Diameter (μm) | Fiber Length (in) |
|---|---|---|
| 14 | 16 | 1.25 |
| 14 | 16 | 1.7 |
| 14 | 20 | 1.25 |
| 14 | 20 | 1.7 |
| 18 | 16 | 1.25 |
| 18 | 16 | 1.7 |
| 18 | 20 | 1.25 |
| 18 | 20 | 1.7 |

Wet chop fiberglass with the lengths and diameters specified in Table 1 above is produced on a bushing line. The fiberglass is then used to make 12″ by 12″ mats (e.g., handsheets using a handsheet former). The handsheet production process includes dispersing wet chop glass fibers in a whitewater medium and laying the fibers in a substantially uniform layer on a 12″ by 12″ screen. The layer then receives an application of the binder, followed by a drying sequence in an oven to form the mat.

Six handsheet mats are made for each of the 8 combinations of glass fiber length, diameter, and binder content listed in Table 1. Several performance characteristics may measured for the mats, including basis weight (lb/100 ft²), LOI (wt. %), tensile strength (lb/in), tear strength (g), thickness (mils), and retention (% of tensile strength retained after hot wet bath). As data from multiple mats is collected for each of the 8 combinations, average values and standard deviations for each measured performance characteristic may be calculated and recorded. For example, performance characteristic measurements for tensile strength and tear strength are compiled in

TABLE 2
Tensile Strength and Tear Strength Measurements in Glass Mats

| Binder | Fiber | Fiber | Tear | Tear | Tensile | Tensile |
|---|---|---|---|---|---|---|
| Content | Diameter | Length | Avg | Stdev | Avg | Stdev |
| (% wt.) | (μm) | (in) | (g) | (g) | (lb) | (lb) |
| 14 | 16 | 1.25 | 488 | 125 | 22.6 | 3.8 |
| 14 | 16 | 1.7 | 595 | 123 | 23.0 | 3.5 |
| 14 | 20 | 1.25 | 514 | 106 | 17.5 | 3.2 |
| 14 | 20 | 1.7 | 578 | 127 | 15.3 | 2.7 |
| 18 | 16 | 1.25 | 427 | 65 | 23.9 | 2.3 |
| 18 | 16 | 1.7 | 441 | 67 | 24.9 | 4.2 |
| 18 | 20 | 1.25 | 444 | 55 | 23.4 | 2.1 |
| 18 | 20 | 1.7 | 506 | 102 | 20.5 | 3.1 |

The collected data on the performance characteristics may is analyzed with computer software (e.g., Minitab's Statistical Software Suite). The analysis of variance (e.g., ANOVA) may be used to determine whether the means of different data sets are statistically different. Regression analysis may be used to explore and model the relationship between an output variable (e.g., a performance characteristic) and one or more input variables (e.g., values of factors). The regression analysis may include finding an optimized model fit by minimizing the sum of the squared errors to obtain a best estimate. For example, Table 3 shows an ANOVA analysis of the data set in Table 2 for the tear strength of the mats:

TABLE 3
Analysis of Tear Strength versus Length, Diameter and Binder Content
(LOI)

| | | | SE | | |
|---|---|---|---|---|---|
| Term | Effect | Coefficient | Coefficient | T | P |
| Constant | | 499.19 | 9.449 | 52.83 | 0.000 |
| Length | 61.42 | 30.71 | 9.449 | 3.25 | 0.031 |
| Diameter | 22.68 | 11.34 | 9.449 | 1.20 | 0.296 |
| LOI | −89.12 | −44.56 | 9.449 | −4.72 | 0.009 |

The statistical significance of each factor (i.e., glass fiber length, glass fiber diameter, and binder content as measured by LOI) may be evaluated based on the value of P. In this example, a P value less than 0.05 indicates a statistical significance for a 95% confidence level. Thus for the tear strength of the mats, glass fiber length and binder content appear statistically significant.

Additional software analysis may be performed to develop a prediction equation for the tear strength of the mats based on the 3 factors. In this example, the prediction equation may be calculated using a least squares method to fit a line through a set of data. Coefficients in the prediction equation are determined using a least squares algorithm that minimizes the sum of squared deviations of each data point from the best fit curve. Table 4 lists the coefficients generated for each of the 3 factors in the prediction equation:

TABLE 4
Calculated Coefficients for the Prediction Equation

| Term | Coefficient |
|---|---|
| Constant | 552.273 |
| Glass Fiber Length | 136.481 |
| Glass Fiber Diameter | 5.67083 |
| Binder Content (measured by LOI %) | −22.2792 |

The coefficients may be used to generate a prediction equation for the tear strength of a manufactured fiberglass mat based on the 3 factors:
Tear Strength (in grams)=136.481 (Fiber Length in inches)+5.67083 (Fiber Diameter in micrometers)−22.2792 (LOI %)+552.273

The prediction equation is used to determine the optimum fiber geometry and LOI to design a mat with desired tear strength. A similar procedure may be used to develop a prediction equation for the tensile strength of fiberglass mats using data from Table 2. Prediction equations for both the tear strength and the tensile strength may be solved simultaneously to find optimal values for the 3 factors to produce a mat with desired tensile and tear strength characteristics.

The tear strength prediction equation was used in conjunction with a tensile strength prediction equation to compare the tear and tensile strength of the end product made with specified production components as compared to a standard fiber. The comparison is presented in Table 5:

TABLE 5
Comparison of Tear and Tensile Strength for Product Designs

| Product Design | Tear Strength | Tensile Strength |
|---|---|---|
| 1.7″ fiber length | 28% | −11% |
| 16 μm fiber diameter | | |
| 14% wt. LOI | | |
| 1.5″ fiber length | 3% | −25% |
| 18 μm fiber diameter | | |
| 14% wt. LOI | | |
| 1.5″ fiber length | 21% | −7% |
| 14.5 μm fiber diameter | | |
| 14% wt. LOI | | |
| 1.5″ fiber length | 30% | −1% |
| 14.5 μm fiber diameter | | |
| 12% wt. LOI | | |

The example illustrates how prediction equations may be used to help design a production process that increases the tear strength of the manufactured product by 30% with minimal adverse impact on its tensile strength. Designing this production process through experimental trial and error without the prediction equations would be less efficient, and more expensive.

In the above example, a prediction equation was developed to predict the tear strength of a fiberglass mat based on 3 factors. It should be appreciated that similar analyses may be performed for other performance characteristics measured in the designed experiment. For example, in fiberglass products such as rolled roofing or shingles, different performance characteristics may be measured.

The systems and methods of the invention may also be used to reduce the cost of fiberglass mat production. For example, performance characteristics of the mat may be predicted while reducing the amount of binder used in the mat, thereby reducing the materials cost of making the mat. By adjusting fiber length and diameter at low binder levels, production processes can be designed that use less binder with minimal impact on the desired performance characteristics of the mat.

The words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups.

1. A method for designing a fibrous non-woven mat production, the method comprising:
selecting various physical characteristics for at least some of the components to be included in the mat;
obtaining empirical performance data relating to the mat based on the selected physical properties;
developing a prediction equation for a performance characteristic of the mat based on the empirical data and the physical characteristics;
calculating performance characteristics using the prediction equation, wherein ranges of at least some of the physical characteristics are used in the prediction equation; and
selecting components for the mat based on the calculated performance characteristics.

2. The method according to claim 1, wherein the empirical performance data is selected from a group consisting of tear strength, tensile strength and dispersion.

3. The method according to claim 1, wherein one of the components comprise glass fiber, and wherein the physical characteristics are selected from the group consisting of fiber length, fiber diameter, and sizing formulation.

4. The method according to claim 3, wherein one of the components comprises a binder, and wherein the physical characteristic comprises binder content by percentage weight.

5. The method according to claim 1, wherein the prediction equation is developed using a regression analysis.

6. The method according to claim 3, wherein the ranges of fiber length vary from about 1.2 inches to about 1.7 inches.

7. The method according to claim 3, wherein the ranges of fiber diameter vary from about 14 micrometers to about 20 micrometers.

8. The method according to claim 4, wherein the ranges of binder content by weight vary from about 14 percent to about 18 percent.

9. The method according to claim 3, wherein the fiber length is about 1.5 inches and the fiber diameter is about 14.5 micrometers.

10. The method according to claim 4, wherein the binder content by weight is about 12 percent.

11. A system for designing a fibrous non-woven mat production, the system comprising:
a processor to develop a prediction equation to calculate one or more production component values based on a performance characteristic value, wherein the prediction equation is developed from data on a performance characteristic of the mat generated by one or more designed experiments; and
a mat production design comprising one or more production values calculated from a desired performance characteristic value input into the prediction equation.

12. The system of claim 11, wherein the performance characteristic is selected from the group consisting of tear strength, tensile strength and dispersion.

13. The system of claim 11, wherein the one or more production components are selected from the group consisting of a materials characteristic and a production characteristic.

14. The system of claim 11, wherein the mat comprises glass fiber, and the one or more production components are selected from the group consisting of fiber length, fiber diameter, and sizing formulation.

15. The system of claim 11, wherein the mat comprises a binder, and the one or more production components includes binder content by percentage weight.

16. The system of claim 14, wherein the fiber length has a range from about 1.2 inches to about 1.7 inches.

17. The system of claim 14, wherein the fiber diameter has a range from about 14 micrometers to about 20 micrometers.

18. The system of claim 15, wherein the binder content by weight has a range from about 14 percent to about 18 percent.

19. The system of claim 11, wherein the prediction equation is developed using a regression analysis.

20. The system of claim 11, wherein the processor is a computer.

21. A method for designing a fibrous non-woven mat production, the method comprising:
selecting physical characteristics for at least some components to be included in the mat, wherein the components include glass fibers and binder, and wherein the physical characteristics include length and diameters of the glass fiber and content, by percentage weight, of the binder;
obtaining empirical performance data relating to the mat based on the selected physical properties, wherein the empirical performance data is selected from the group consisting of tear strength, tensile strength and dispersion;
developing a prediction equation for a performance characteristic of the mat based on the empirical data and the physical characteristics;
calculating performance characteristics using the prediction equation, wherein ranges of at least some of the physical characteristics are used in the prediction equation; and
selecting components for the mat based on the calculated performance characteristics.
